(19) United States
(12) Patent Application Publication
(10) Pub. No.: US 2012/0207217 A1
(43) Pub. Date: Aug. 16, 2012

(54) VIDEO CODING BASED ON GLOBAL MOVEMENT COMPENSATION

(75) Inventors: Edouard Francois, Cesson Sevigne Cedex (FR); Dominique Thoreau, Bourg Des Comptes (FR); Jerome Vieron, Paris (FR); Aurelie Martin, Paris (FR)

(73) Assignee: THOMSON LICENSING, Issy-les-Moulineaux (FR)

(21) Appl. No.: 12/998,921

(22) PCT Filed: Dec. 18, 2009
(86) PCT No.: PCT/FR09/52625

§ 371 Date: May 4, 2012

(30) Foreign Application Priority Data
Dec. 19, 2008 (FR) 0858833
Dec. 19, 2008 (FR) 0858834

(51) Int. Cl. H04N 7/36

(52) U.S. Cl. 375/240.16; 375/E07.262

(57) ABSTRACT

A method for video coding of at least one digital picture sequence is disclosed. The pictures of said sequence can be intermediary pictures or key pictures used as references for the coding by motion compensation of intermediary pictures. The intermediary pictures are coded per area based on a global motion compensation GMC in the forward and backward direction from key pictures, the areas of the intermediary picture being constituted either by merging of global motion compensated key picture areas, or by conventional coding, the choice between merging and conventional coding being made according to the result of a measurement of coherency between the signals of global motion compensated key picture areas. A video coding device and a video decoding device are also disclosed.

The invention relates to a method for estimation and coding of global motion parameters of a sequence of video pictures as well as a method and device for coding video pictures based on global motion compensation. It applies notably to the domains of the transmission, analysis, decoding and transcoding of videos.

A video sequence comprises by its nature a high statistical redundancy both in the temporal and spatial domains. The desire to always use more efficiently the transmission media bandwidths on which these sequences transit and the objective of reducing the cost of their storage posed the question very early on of video compression. The standard video compression techniques can generally be divided into two steps. The first aims to reduce the spatial redundancy and to do this to compress a still picture. The picture is first divided into blocks of pixels (of 4×4 or 8×8 according to, for example, the MPEG-1/2/4 standards), a passage into the frequency domain followed by a quantization enabling the approximation or deletion of high frequencies to which the eye is less sensitive, and finally the quantized data are coded in an entropic manner. The purpose of the second step is to reduce the temporal redundancy. This technique enables a picture to be predicted, called an intermediary picture in the remainder of the description, from one or more other reference pictures previously decoded within the same sequence. In other words, an estimation of motion is carried out. This technique consists in searching in these reference pictures for the block that best corresponds to that to be predicted, and only a motion estimation vector is retained corresponding to the displacement of the block between the two pictures as well as a residual error enabling the visual rendering to be refined.

In order to improve the coding efficiency, notably at low and medium bitrate, and thus to obtain for equivalent bitrates a better visual quality of the decoded video, a technique called global motion compensation designated hereafter in the description by the abbreviation GMC (Global Motion Compensation) has been proposed. Numerous models of global motion for video compression exist in the prior art. This model type was notably introduced in the “MPEG-4 Visual” standard also called “MPEG-4 part 2” as well as in the DivX or Dirac standards.

In the approaches developed, for a given picture, the global motion between said picture and its reference pictures is estimated over the entire picture or per region. The reference pictures compensated by the associated global motion then become possible candidates for temporal prediction, in the same way as the reference pictures compensated by non-global motions, that is to say with standard coding methods. The standard coding methods usually rely on the use of a motion vector per block or per several blocks when the temporal prediction is multi-directional, that is to say that it relies on several reference pictures. The interest in the use of GMC is a significant reduction of the cost of motion information on the zones of the picture where it applies. Temporal prediction is also improved (one motion vector per pixel and not per block) with respect to a representation of the motion based on a translation vector per block.

Video coding schemas now use GMC models. The article by Steinbach, Wiegand and Girod entitled Using multiple global motion models for improved block-based video coding, ICIP 1999, vol. 2, pp. 56-60, October 1999, details this model type. For each picture where these models apply, an estimation and a coding of global motion parameters are carried out. This is particularly true in bi-directional pictures, also called type B pictures and intermediary pictures, where the estimation and coding are carried out successively in the forward and backward directions.

This approach presents several disadvantages. As the estimation of the set of parameters is made in one direction then in another, the calculation complexity is significant. The estimation consists in general in identifying the global motion that minimises the average quadratic error between the current picture (or a region of this picture) and the reference picture (or a region of this picture) motion compensated, and this while proceeding to a resolution to the least square. This estimation leads to a set of parameters, or a vector, designated by the Greek letter θ. An estimation \hat{θ} of vectors of parameters θ can be obtained using the following expression:

$$\hat{θ} = {argmin}_{θ} ( {\sum }_{p ∈ R} {( B [ p ] - {I}_{ref} [ x - {u}_{θ} ( p ) , y - {v}_{θ} ( p ) ] )}^{2} ) \qquad ( 1 )$$

wherein p=(x,y) designates the position of a pixel in the picture, R the processing region, B the current picture to be coded, I_{ref} the reference picture and (u_{θ},v_{θ}) the components of the motion vector a function of the vector of motion global parameters θ.

In the case of a refined model for example, θ represents a vector of 6 parameters and there are thus 2×6 parameters to be estimated per global motion, or 6 for the forward motion and 6 for the backward motion.

Usually, the function to be minimized is linearized by an approximation based on a Taylor development. This can be described by the following expression:

$$\hat{θ} = {argmin}_{θ} ( {\sum }_{p ∈ R} {( {B}_{i} [ p ] - {u}_{θ} ( p ) \cdot {B}_{x } [ p ] + {v}_{θ} ( p ) \cdot {B}_{y} [ p ] )}^{2} ) \qquad ( 2 )$$

in which Bₜ, Bₓ and B_{y} designate respectively the horizontal spatial and vertical spatial temporal gradients of the signal B. The resolution to the least squares then returns to the resolution of a linear system at N equations, N corresponding to the size of the global motion model.

An iterative resolution to the least weighted squares is usually applied in order to resolve the problem of image samples that do not respond to the global motion, said samples being usually designated by the term “outlier”. A description of this estimator type, designated by the expression “M-estimator” can be found in the article by J. W. Tukey entitled Explorary Data Analysis, 1977, Addison-Wesley, Reading, Mass.

Another disadvantage is due to the fact that the estimation is carried out in one direction and then in another. Consequently, there may be incoherencies between the front and back estimated motion parameters. This can be disturbing in particular in an approach in which either the front indicator or the back indicator is chosen locally for the coding of the intermediary image to motion compensate rigid textures. This is the case notably in the approach proposed in the article by Ndjiki-Nya, Hinz, Stüber and Wiegand entitled A content-based video coding approach for rigid and non-rigid textures, ICIP'06, Atlanta, Ga., USA, pp. 3169-3172, October 2006. Motion incoherencies, even slight, can have a disagreeable visual effect due to temporal fluctuations of the signal.

A third disadvantage is a consequence of the fact that the motion parameters are coded for both the forward and backward directions. If a hierarchical type B GOP (Group of Picture) structure is employed, the coding cost of these parameters can become significant. This can become a problem when a low or very low transmission bitrate is targeted for a given application.

For that which relates to the coding of video pictures using global motion compensation (GMC), in a conventional schema, even in the case of bi-directional prediction using a mixture of forward and backward prediction, the compensation usually only applies in one direction, forwards and/or backwards, which can generate temporal incoherencies between the forward and backward compensated versions and degrade the visual display through temporal fluctuations on the related areas. Moreover, intermediary pictures using as a reference areas reconstructed from a global motion do not actually use this temporal incoherence information between the forward and backward predictions. Another disadvantage of existing coding schemas is that the areas using a global motion must be signalled. This typically implies the requirement to code an item of information for each block of the picture. In addition a coding residue is in general coded and if this is not the case, it must be signalled to the decoder. It is also important to note that the decoding method based on the GMC technique is totally determined and not adaptable to the complexity of the terminal carrying out the decoding of the video stream.

One purpose of the invention is notably to overcome the aforementioned disadvantages.

To this end the purpose of the invention is a method for estimation and coding of motion parameters of a sequence of video pictures composed of grouped of pictures GOP, a GOP comprising at least two reference pictures and at least one intermediary picture, the calculation of a field of motion vectors of a picture or a given picture part with respect to at least one picture or a reference picture part within a GOP being based on the calculation of vectors of global motion parameters, the vectors of “backwards” parameters describing the fields of motion vectors between a picture or a given picture part and a picture or an already coded reference picture part preceding it, the vector of “forward” parameters describing the field of motion vectors between a picture or a given picture part and a picture or an already coded reference picture part following it. The vectors of “forward” and “backward” parameters associated with the pictures or intermediary picture parts are expressed according to the vector of parameters describing the motions between two pictures or reference picture parts.

A given vector of global motion parameters can be composed of a pair M, T, the first term of the pair M corresponding to a matrix of dimensions 2×2 and the second term T of the pair corresponding to a matrix of dimensions 2×1.

A global estimation of motion is carried out between two pictures or reference image parts of a given GOP in a way to estimate a vector of global motion parameters θ=(M,T) linking the pixels of pictures or reference picture parts according to the expression X_{A}=(I−M)X_{C}−T

wherein:
X_{A} represents the position of a pixel of the first reference picture at coordinates x_{A} and y_{A}, and
X_{C}represents the position of a pixel of the second reference picture (C) at coordinates x_{C} and y_{C}.

The estimation of vectors of global motion “backward” parameters θ₀=(M₀,T₀) and “forward” parameters θ₁=(M₁,T₁) of a picture or part of an intermediary picture of a given GOP with respect to two pictures or parts of the reference picture of said GOP is carried out, for example, in a way to connect the pixels of the picture or intermediary picture part to the pixels of pictures or reference picture Darts according to the expressions:

$$\{ \begin{matrix}{X}_{A} = ( I - {M}_{0} ) {X}_{B} - {T}_{0} \\ {X}_{C} = ( I - {M}_{1} ) {X}_{B} - {T}_{1}\end{matrix}$$

According to an aspect of the invention, the estimation of vectors of “backward” θ₀=(M₀,T₀) and “forward” θ₁=(M₁,T₁) global motion parameters of a picture or intermediary picture part is constrained to two degrees of freedom by deducing θ₀ and θ₁ from two parameters α₀ and α₁ verifying the equations:

$$\{ \begin{matrix}{M}_{0} = {α}_{0} \cdot M \\ {T}_{0} = {α}_{0} \cdot T\end{matrix} and \{ \begin{matrix}{M}_{1} = {α}_{1} \cdot [ I - {( I - M )}^{- 1} ] \\ {T}_{1} = {α}_{1} \cdot [ - {( I - M )}^{- 1} \times T ]\end{matrix}$$

An estimation \hat{α}₀ of the parameter α₀ can be obtained using the expression:

$${\hat{α}}_{0} = \frac{{\sum }_{p ∈ R} ( {B}_{i , {θ}_{0}} [ p ] {s}_{θ} ( p ) )}{{\sum }_{p ∈ R} {S}_{θ}^{2} ( p )}$$

wherein:

S_{θ}(p)=u_{θ}(p)·Bₓ[p]+v_{θ}(p)·B_{y}[p]; and
Bₓ[p] and B_{y}[p] are the horizontal spatial and vertical spatial gradients of the signal of the intermediary picture, and
u_{θ} and v_{θ} are the components of the motion vector according to the global motion parameters vector θ.

For example, only two parameters α₀ and α₁ are coded to represent the global parameters vectors θ₀ and θ₁.

According to another aspect of the invention, the estimation of “backward” θ₀=(M₀,T₀) and “forward” θ₁=(M₁,T₁) global motion parameters of an intermediary picture is constrained to one degree of freedom by deducing θ₀ and θ₁ from a parameter a verifying the equations:

$$\{ \begin{matrix}{M}_{0} = α \cdot M \\ {T}_{0} = α \cdot T\end{matrix} and \{ \begin{matrix}{M}_{1} = ( α - 1 ) \cdot {( I - M )}^{- 1} M \\ {T}_{1} = ( α - 1 ) \cdot {( I - M )}^{- 1} T\end{matrix}$$

An estimation \hat{α} of the parameter α is obtained, for example, using the expression:

$$\hat{α} = \frac{{\sum }_{p ∈ R} ( {B}_{t , {θ}_{0}} [ p ] {S}_{θ} ( p ) + {B}_{t , {θ}_{1}} [ p ] {S}_{{θ}^{″}} ( p ) - {S}_{{θ}^{″}}^{2} ( p ) )}{{\sum }_{p ∈ R} ( {S}_{θ}^{2} ( p ) + {S}_{{θ}^{″}}^{2} ( p ) )}$$

wherein:

S_{θ}(p)=u_{θ}(p)·Bₓ[p]+v_{θ}(p)·B_{y}[p]; and

S_{θ″}(p)=u_{θ″}(p)·Bₓ[p]+v_{θ″}(p)·B_{y}[p]; and
θ″ corresponds to the parameters pair ((I−M)⁻¹×M, (I−M)⁻¹×T), and
u″_{θ} and v″_{θ} are the components of the motion vector according to the global motion parameters vector θ″.

For example, only the parameter α is coded to represent the global parameters vectors θ₀ and θ₁.

The purpose of the invention is also a coding device for at least one video sequence, said sequence being composed of groups of pictures GOP, a GOP comprising at least two reference pictures and at least one intermediary picture. The motion vectors field of a picture or of a given picture part with respect to at least one picture of reference picture part within a GOP is estimated by calculating global motion parameters vectors. The “forward” and “backward” parameters vectors associated with the pictures or intermediary picture parts are coded by implementing the method for coding according to the invention.

The purpose of the invention is also a device for decoding video picture sequences composed of groups of pictures GOP, a GOP comprising at least two reference pictures and at least one intermediary picture. The field of motion vectors of a picture or of a given picture part with respect to the at least one picture or one reference picture part with a GOP is reconstructed, the vectors of “forward” θ₁=(M₁,T₁) and “backward” θ₀=(M₀,T₀) parameters of said field associated with the pictures or intermediary picture parts being deduced from the at least one parameter linking these vectors to the at least one vector of parameters describing the motions between two pictures or reference picture parts, said parameter having been previously coded using the method for coding according to the invention.

The purpose of the invention is also a method for video coding of at least one digital picture sequence, the pictures of said sequence can be intermediary pictures or key pictures used as references for the coding by motion compensation of intermediary pictures. The intermediary pictures are coded per area based on a global motion compensation GMC in the forward and backward direction from key pictures, the areas of the intermediary picture being constituted either by merging of global motion compensated key picture areas, or by conventional coding, the choice between merging and conventional coding being made according to the result of a measurement of coherency between the signals of global motion compensated key picture areas.

For example, the reference pictures are coded before the intermediary pictures and at least one segmentation map associated with said pictures is calculated in a way to be able to distinguish the GMC type pixels from other pixels of these pictures.

The global motion parameters can be estimated and coded before the coding of intermediary pictures.

According to an aspect of the invention, motion compensated key pictures are deduced from key pictures using at least the global motion parameters.

Segmentation maps associated with the motion compensated pictures can be deduced from segmentation maps associated with the key pictures by transpositions using at least the motion estimation parameters.

The intermediary picture to be coded as well as the motion compensated key pictures used for its coding are, for example, divided into processing areas, the processing areas corresponding to the processing areas of motion compensated key pictures.

According to an embodiment of the invention, the processing areas of motion compensated key pictures are classed according to their proportion of GMC pixels, said proportion being compared to a threshold η comprised between 0 and 1, an area being classed “GMC” when said proportion is greater than η and classed “non-GMC” in the contrary case.

According to another embodiment of the invention, the proportion of GMC pixels per area of motion compensated pictures us deduced from segmentation maps.

If at least one area of one of the motion compensated pictures and used as references for the coding of the area to be coded of an intermediary picture is classed “non-GMC”, a conventional coding of said area can be carried out.

According to another aspect of the invention, if the areas of motion compensated pictures used as references for the coding of an area of an intermediary picture are classed “GMC”, the coherence of said areas is analysed by comparison of signals of areas of global motion compensated key pictures.

The areas of key pictures motion compensated by the taking into account of global compensation parameters for which the coherence must be analysed are, for example, motion compensated a second time using a translation vector of a precision to the nearest pixel.

The translation vector of the second motion compensation can be calculated using a “block matching” type estimator.

According to an embodiment, the average quadratic error D of the area to be coded is calculated and is compared to a predefined threshold λ in a way to distinguish the areas with low local gradient from areas with high local gradient, the area being considered to have low local gradient and is classed “coherent” if D is less than λ and being considered to have high local gradient in the contrary case.

A higher limit S than the average quadratic error D is calculated, for example, using the values of local gradients of the current area and the average quadratic error D is compared with said limit S, the current area being classed “coherent” when D is less than this limit and “non-coherent” in the contrary case.

When the area to be coded is classed “coherent”, the merging of corresponding areas of motion compensated key pictures can be carried out.

The merge is carried out, for example, using a “Graph cut” type algorithm.

According to an embodiment, when the area being processed is classed “non-coherent”, the conventional coding of said area is carried out.

The purpose of the invention is also a device for video picture coding of at least one digital picture sequence, the pictures of said sequence can be intermediary pictures or key pictures used as references for the coding by motion compensation of intermediary pictures. The coding device comprises means for coding intermediary pictures per processing area based on a global motion compensation GMC in the forward and backward directions from key pictures, the processing areas of the intermediary picture being coded either by merging of corresponding areas of key pictures, or by conventional coding and to automatically choose between merging and conventional coding by analysis of the area to be coded.

The purpose of the invention is also a device for video picture decoding of at least one digital picture sequence previously coded using the method for coding according to the invention, the pictures of said sequence can be intermediary pictures or key pictures used as references for the decoding by motion compensation of intermediary pictures. The intermediary pictures are decoded per area based on a global motion compensation GMC in the forward and backward direction from decoded key pictures, the areas of the intermediary picture being reconstructed either by merging of global motion compensated key picture areas, or by conventional decoding, the choice between merging and conventional decoding being made according to the result of a measurement of coherency between the signals of global motion compensated key picture areas.

The invention notably has the advantage of improving the coding efficiency, by reduction of the bitrate required while potentially improving the visual quality of the coded/decoded video sequence. In the sequences where only some foreground objects move in the scene, the use of this method induces a significant reduction of the bitrate of the compressed video stream with respect to existing techniques. Moreover, the visual artefacts due to temporal fluctuations of the signal in these areas are limited by the employment of the method.

Other characteristics and advantages of the invention will emerge with the help of the description that follows provided as a non-restrictive example, made with regard to the annexed drawings wherein:

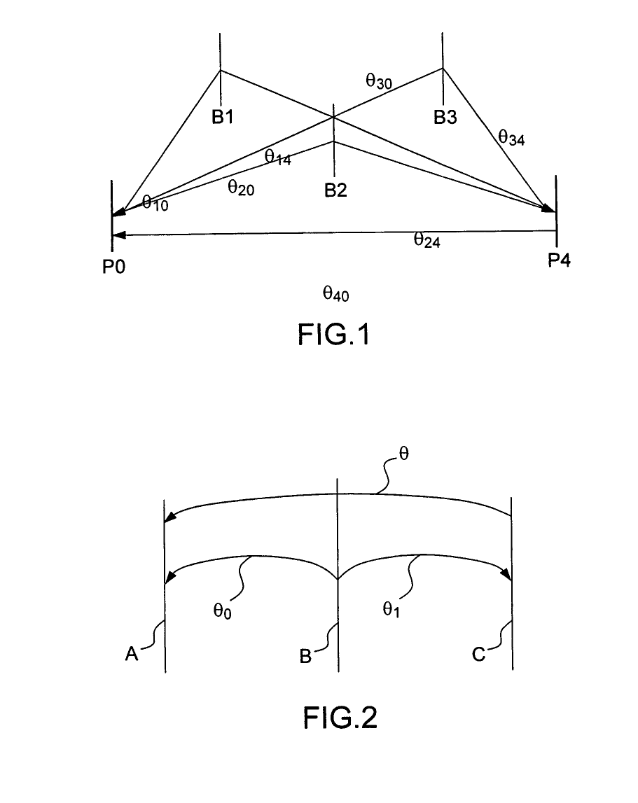

FIG. 1 shows an example of a GOP comprising three intermediary pictures based on two reference pictures,

FIG. 2 shows the case of an intermediary picture for which the coding is based on two reference pictures, this case being used in a way to provide an embodiment of the invention,

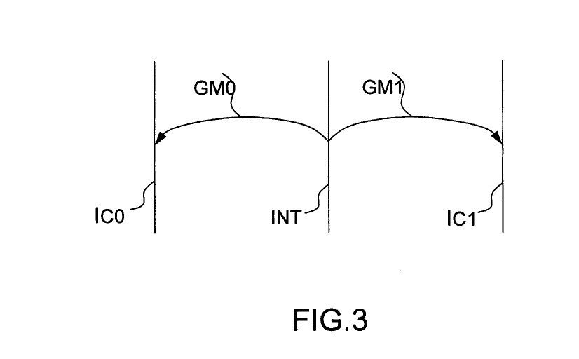

FIG. 3 shows the principle of temporal dependence between key pictures and intermediary pictures,

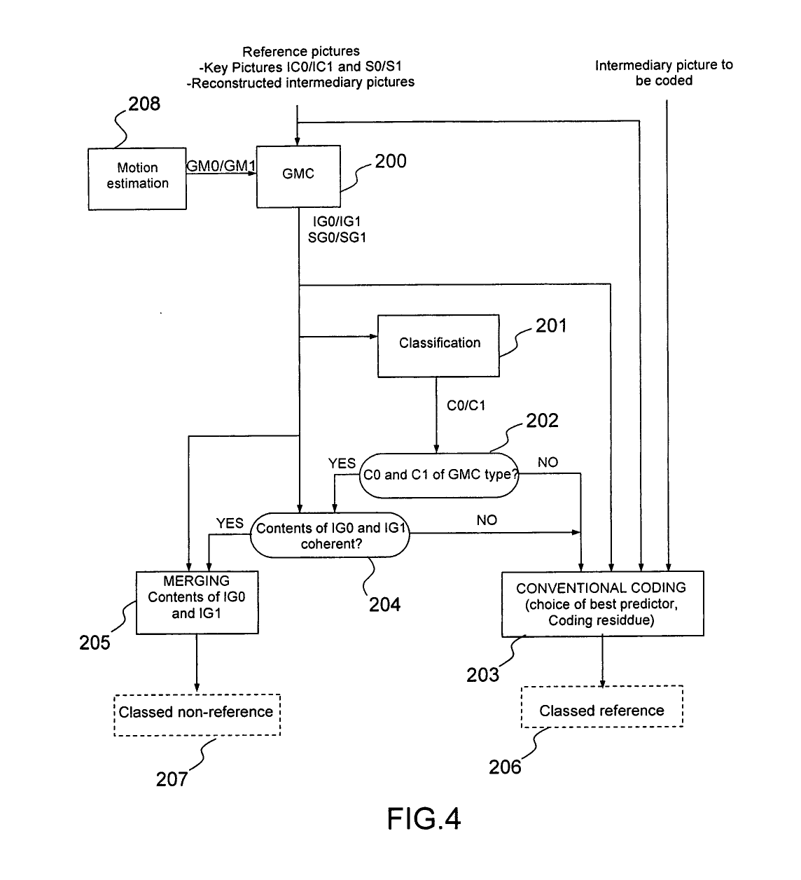

FIG. 4 provides an embodiment of the method for coding according to the invention,

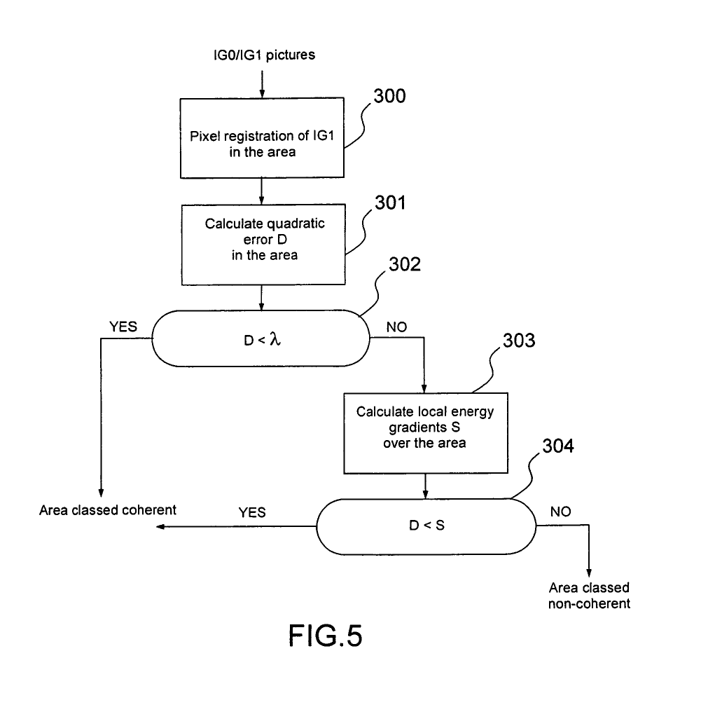

FIG. 5 shows a method for testing the coherence of an area on two different pictures.

FIG. 1 shows an example of a GOP comprising three intermediary pictures based on two reference pictures. In other words, this example represents a hierarchical GOP at 3 levels. Two pictures P0 and P4 are used as references to code the intermediary pictures B1, B2 and B3. There are then 7 sets of parameters to code per GOP, θ₁₀ and θ₁₄ for the picture B1, θ₂₀ and θ₂₄ for the picture B2, θ₃₀ and θ₃₄ for the picture B3 and θ₄₀ for the picture P4. In this example, a global motion estimation is carried out between the reference pictures P0 and P4, said motion estimation leading to the parameters set θ₄₀.

In the scope of the invention, it is proposed to restrict the degree of freedom of motion parameters when the estimation and the coding of different global motion parameters sets. This can be implemented based on the global motion between the two reference pictures. This constraint is expressed using one or two parameters that are then the only parameters to be estimated and coded to describe both the forward motion parameters and the backward motion parameters.

The invention notably proposes a method for estimation of these parameters.

FIG. 2 shows the case of an intermediary picture for which the coding is based on two reference pictures, this case being used in a way to provide an embodiment of the invention.

The intermediary picture B is located between to reference pictures A and C, between which a “backward” estimation of global motion has been carried out, and the vector of associated parameters θ has been coded. The model of motion used is a linear model, also called a refined model, being expressed by the following expression:

X_{A}=(I−M)X_{C}−T (3)

wherein X_{K}=(x_{K}, y_{K}) represents the position of a pixel of the picture K, K being the value of A, B or C, I is the matrix identity of dimensions 2×2, M is a matrix of dimensions 2×2 and T a matrix of dimensions 2×1 for which the elements correspond to the global motion parameters.

Moreover, it is possible to express X_{A} and X_{C} using the following expressions:

$$\{ \begin{matrix}{X}_{A} = ( I - {M}_{0} ) {X}_{B} - {T}_{0} \\ {X}_{C} = ( I - {M}_{1} ) {X}_{B} - {T}_{1}\end{matrix} \qquad ( 4 )$$

Knowing θ=(M, T) that had been previously estimated and coded, one sought for goal is notably to identify and code the “backward” θ₀=(M₀, T₀) and “forward” θ₁=(M₁, T₁) global motion parameters while limiting their coding cost. Another objective is to ensure coherency between θ₀, θ₁ and θ in order to ensure good temporal coherency of the motion compensation in the intermediary picture B.

To attain these objectives previously cited, it is possible to implement, for example, two solution types, one with two degrees of freedom and the other with one degree of freedom. These two examples are explained hereafter in the description.

A first embodiment of the invention, with two degrees of liberty, has as a principle to impose independent constraints on the parameters θ₀ and θ₁. These restrictions impose on the pairs (M₀, T₀) and (M₁, T₁) to be proportional to the pair (M, T). This is translated by the following expressions:

$$\{ \begin{matrix}{M}_{0} = {α}_{0} \cdot M \\ {T}_{0} = {α}_{0} \cdot T\end{matrix} \{ \begin{matrix}{M}_{1} = {α}_{1} \cdot {M}^{′} \\ {T}_{1} = {α}_{1} \cdot {T}^{′}\end{matrix} \qquad ( 5 )$$

wherein θ′=(M′,T′) corresponds to the global motion from A to C. It is then easy to demonstrate from the equation (3) that M′=I−(I−M)⁻¹ and T′=−(I−M)⁻¹×T. In this case, only the two scalar parameters α₀ et α₁ must be estimated and coded to characterize the forward and backward global motions.

At the coder level, the motion estimation of α₀ returns then to resolve the following expression \hat{α}₀ being an estimation of α₀:

$${\hat{α}}_{0} = {argmin}_{a} ( {\sum }_{p ∈ R} {( {B}_{t , {θ}_{0}} [ p ] + α \cdot {u}_{θ} ( p ) \cdot {B}_{x} [ p ] + α \cdot {v}_{θ} ( p ) \cdot {B}_{y} [ p ] )}^{2} ) \qquad ( 6 )$$

wherein B_{t,θ}_{⁰}[p] is the gradient between the current picture and the preceding picture compensated by the global motion θ₀ and based on the difference between the current picture and the motion compensated reference picture.

The resolution of this equation leads to the expression:

$${\hat{α}}_{0} = \frac{{\sum }_{p ∈ R} ( {B}_{t , {θ}_{0}} [ p ] {S}_{θ} ( p ) )}{{\sum }_{p ∈ R} {S}_{θ}^{2} ( p )} \qquad ( 7 )$$

wherein S_{θ}(p)=u_{θ}(p)·Bₓ[p]+v_{θ}(p)·B_{y}[p].

In an iterative resolution of least weighted squares type, only the temporal gradient B_{t,θ}_{⁰}[p] depends on α. The other terms can only be calculated at the first iteration. The motion estimation is obviously simplified with respect to a complete estimation according to the expression (2) as a single parameter is estimated instead of N, N being the dimensions of the motion model.

For the estimation of α₁, it suffices to replace in the expression (7) θ with θ′ and θ₀ with θ₁.

At the level of a coder or of a decoder, knowing that θ has been previously coded (or decoded), it suffices then to only code (or decode) the parameters \hat{α}₀ and \hat{α}₁ instead of the set of parameters of the vectors θ₀ and θ₁, which reduces considerably the cost of coding global motion information. θ₀ and θ₁ are then deduced from \hat{α}₀, \hat{α}₁ and θ using equations (5).

A second embodiment of the invention, with one degree of freedom, has as a principle to impose a constraint on the parameters M₀ and T₀, and to deduce from them the values of M₁ and T₁. In this case, only one scalar parameter a must be estimated and coded (or decoded) to characterize the forward and backward global motions.

M₀ and T₀ are then constrained to be proportional to M and T. This is translated by the following expression:

$$\{ \begin{matrix}{M}_{0} = α \cdot M \\ {T}_{0} = α \cdot T\end{matrix} \qquad ( 8 )$$

By combining the expressions (3), (4) and (8), it is easy to connect the pair (M₁, T₁) to the pair (M, T) by the expressions:

$$\{ \begin{matrix}{M}_{1} = ( α - 1 ) \cdot {( I - M )}^{- 1} M \\ {T}_{1} = ( α - 1 ) \cdot {( I - M )}^{- 1} T\end{matrix} \qquad ( 9 )$$

Thus, having coded (or decoded) α and knowing θ, θ₀ is deduced by θ₁ due to the expressions (8) and (9).

At the coder, for the estimation of α, a sub-optimal solution is to proceed while taking account of only one direction while being based on the expression (7). The optimisation can also be made, for example, by taking account of the two forward (parameter θ₀) and backward (parameter θ₁) motion compensated pictures, according to the following expression:

$${\hat{α}}_{0} = {argmin}_{a} ( \begin{matrix}{\sum }_{p ∈ R} {( \begin{matrix}{B}_{t , {θ}_{0}} [ p ] + α \cdot {u}_{θ} ( p ) \cdot \\ {B}_{x} [ p ] + α \cdot {v}_{θ} ( p ) \cdot {B}_{y} [ p ]\end{matrix} )}^{2} + \\ {\sum }_{p ∈ R} {( \begin{matrix}{B}_{t , {θ}_{1}} [ p ] + ( α - 1 ) \cdot {u}_{{θ}^{″}} ( p ) \cdot \\ {B}_{x} [ p ] + ( α - 1 ) \cdot {v}_{{θ}^{″}} ( p ) \cdot {B}_{y} [ p ]\end{matrix} )}^{2}\end{matrix} ) \qquad ( 10 )$$

wherein θ″=((I−M)⁻¹×M, (I−M)⁻¹×T). The resolution of this equation leads then to the expression:

$$\hat{α} = \frac{{\sum }_{p ∈ R} ( {B}_{t , {θ}_{0}} [ p ] {S}_{θ} ( p ) + {B}_{t , {θ}_{1}} [ p ] {S}_{{θ}^{″}} ( p ) - {S}_{{θ}^{″}}^{2} ( p ) )}{{\sum }_{p ∈ R} ( {S}_{θ}^{2} ( p ) + {S}_{{θ}^{″}}^{2} ( p ) )} \qquad ( 11 )$$

wherein S_{θ}(p)=u_{θ}(p)·Bₓ[p]+v_{θ}(p)·B_{y}[p] and S_{θ″}(p)=u_{θ″}(p)·Bₓ[p]+v_{θ″}(p)·B_{y}[p].

FIG. 3 shows the principle of temporal dependence between reference pictures, called key pictures in the remainder of the description, and intermediary pictures. The example of the figure considers a group of pictures, usually designated by the abbreviation GOP (Group of Pictures) formed of two key Pictures IC0, IC1 and framing one or more intermediary pictures INT. The method for coding according to the invention operates in the processing areas able to correspond, for example, to one or more blocks or macroblocks.

The key pictures of the GOP IC0 and IC1 are coded first. The coding is carried out according to a conventional approach, the GMC based coding tool can also be implemented. Thus some areas of a key picture can be coded or serve as a reference, with a GMC prediction and others can not. It is then possible to deduce at coder and decoder level a binary segmentation map indicating if an area, and thus the pixels that compose it, is of GMC type or not.

The invention relates notably to the coding of intermediary pictures INT. For an area to be coded of a given intermediary picture, it is assumed hereafter in the description that the forward and backward global motion parameters noted as GM0 and GM1 have been previously estimated and coded. It is also taken as hypothesis that the key pictures IC0 and IC1 are reconstructed in order to serve as reference pictures, the intermediary pictures already coded can also be available as reference pictures. Finally, a binary segmentation map is calculated for each picture by the decision module of the encoder and indicates for each pixel of the reference picture if it is of GMC type or not.

FIG. 4 provides an embodiment of the method for coding according to the invention.

The method for coding can be broken down into several steps.

A first step 200 carries out the global motion compensation GMC of key pictures IC0 and IC1. Their associated segmentation maps S0 and S1, previously determined by a decision module of the encoder, or by decoding of the coding modes at the decoder, are used at input, as well as the motion parameters GM0 and GM1 determined previously by a motion parameters estimation module 208. The pictures IG0 and IG1 are then obtained, these latter corresponding respectively to the pictures IC0 and IC1 motion compensated according to the motion modules GM0 and GM1. Moreover, two segmentation maps SG0 and SG1 associated with the pictures IG0 and IG1 are translated from segmentation maps S0 and S1 by motion compensation according to the motion models GM0 and GM1.

The intermediary picture to be coded is divided into processing areas. This division can be automatic or adaptive. For example, a processing area can correspond to a macroblock of the picture to be coded. A succession of lo steps is then applied for each of the areas of the intermediary picture to be coded. In the remainder of the description, the area being processed is called the “current area”.

A classification 201 of corresponding areas is carried out based on the segmentation maps SG0 and SG1. Each area is associated, for example, with one class from two possible classes. Each of said classes identifies respectively a “GMC” or “non-GMC” area. Hence, for the current area, a variable C0 associated with IG0 relates this class information. In the same way, a variable C1 is associated with IG1. For example, the two classes can be defined by counting the proportion of pixels classed “GMC” of the picture in the area considered and comparing this proportion with a given threshold η comprised between 0 and 1, and this using segmentation maps SG0 and SG1.

It is also possible to not use the maps S0, S1, SG0 and SG1. In this case, C0 and C1 are, for example, systematically considered as “GMC”.

It is then verified 202 if C0 and C1 are of GMC type. In this embodiment, if C0 or C1 are not of “GMC” type, a conventional coding 2032 of the area is carried out. This conventional coding can be, for example, of spatial prediction type, mondirectional temporal prediction or bidirectional temporal prediction. Conventional coding can still employ GMC prediction but this will be one mode among others that must be signalled to the decoder in the binary stream.

When C0 and C1 are of “GMC” type, the coherence in the area considered of pictures IG0 and IG1 is tested 204. The notion of coherence between pictures areas is detailed later in the description.

If the contents of said pictures are considered coherent, the signal is generated by merging 205 of the processed area of IG0 and IG1, which implies that no information needs to be coded. The areas constructed by merging do not require the coding of any additional information and thus correspond to a null coding cost, which is obviously very advantageous if said areas are numerous. The coding mode thus implemented is an implicit mode, that requires no signalling information. This coding mode, tested on the coder side, is also tested on the decoder side. The decoder is then itself capable, without signalling information, of knowing if the current area is constructed according to this implicit GMC coding mode or not.

If the contents are noticeably different, and thus the coherence is not verified, a conventional coding 203 of the area is carried out. The GMC prediction can still be used as one of the possible prediction modes.

The intermediary picture coded using the method according to the invention is thus composed of predicted areas 207 that can not be used as a reference for the coding of other intermediary pictures and reconstructed areas 206 can be, for their part, used as references for the coding of other pictures.

The method for coding, described above on the encoder side, can apply symmetrically to the decoder. The key pictures of the GOP IC0 and IC1 are decoded first. The decoder, from coding modes decoded from key pictures, constructs for each key picture IC0 and IC1 a binary segmentation map S0 and S1 indicating if an area, and thus the pixels that compose it, is of GMC type or not.

The invention relates notably to the decoding of intermediary pictures INT. For an area to be decoded of a given intermediary picture, the forward and backward global motion parameters noted as GM0 and GM1 are previously decoded.

The method for decoding can be broken down into several steps.

A first step carries out the global motion compensation GMC of key pictures IC0 and IC1. The pictures IG0 and IG1 are then obtained, these latter corresponding respectively to the picture IC0 and IC1 motion compensated according to the motion models GM0 and GM1. Moreover, two segmentation maps SG0 and SG1 associated with the pictures IG0 and IG1 are translated from segmentation maps S0 and S1 by motion compensation according to the motion models GM0 and GM1.

The intermediary picture to be decoded is divided into processing areas. This division can be automatic or adaptive. For example, a processing area can correspond to a macroblock of the picture to be coded. A succession of steps is then applied for each of the areas of the intermediary picture to be coded.

A classification of corresponding areas is carried out relying on the segmentation maps SG0 and SG1.

It is then verified if C0 and C1 are of GMC type. In this embodiment, if C0 or C1 are not of “GMC” type, a decoding of coding information (coding mode, associated parameters—for example direction of intra prediction, motion vectors—prediction residue) for the current area is carried out. This information must then be present in the binary stream.

When C0 and C1 are of “GMC” type, the coherence in the area considered of pictures IG0 and IG1 is tested.

If the contents of said pictures are considered coherent, the signal is generated by merging of the processed area of IG0 and IG1, which implies that no information needs to be decoded. The areas constructed by merging do not require the decoding of any additional information.

If the contents are noticeably different, and thus the coherence is not verified, a decoding of the coding information is carried out. This information must then be present in the binary stream.

FIG. 5 shows a method for testing the coherence of an area on two different pictures. The concept of coherence between pictures was introduced with the preceding figure. The coherence measurement of two signals IG0 and IG1 in the current area can be made by standard measurements of distortion, such as the average quadratic error. However, due to possible limitations of the global motion estimator and the quantization required during the coding of global motion parameters, the signals IG0 and IG1 will never be perfectly aligned and a slight deviation has a very high chance of appearing, even if the two signals are judged to be coherent. This deviation can be all the more significant as the motion model differs from a translational model, that is to say a model where all the pixels of an area displace according to the same vector. In this case, the motion depends on the position of the pixel. When distant from the point of origin, a minor error of a non-translational component of the model will be translated by a significant deviation of the motion vector from the model. The average quadratic error alone does not enable this possible deviation to be taken into account.

In order to take account of this deviation, an approach is proposed within the scope of the invention.

The purpose of a first step 300 is notably a pixel registration of IG1 pixel by local motion compensation of IG1 with respect to IG0. This compensation is made with a translation vector, of a precision to the pixel, and with a limited maximum range value excₘₐₓ. The range value is for example 2 or 3 pixels. To do this a standard “block matching” type estimator can be used. The purpose of this algorithm type is to search for a vector minimising the average quadratic error. This is implemented in order to correct the significant deviations due to errors of the motion model.

During a second step, the average quadratic error is calculated 301 over the current area. This error D can be expressed with the following expression:

$$D = {\sum }_{p ∈ Z} {( IG 0 [ p ] - IG {1}_{mc} [ p ] )}^{2} \qquad ( 1 )$$

wherein Z designates the area being considered, p a pixel and IG1_{mc} the motion compensated picture of IG1.

It is possible to integrate into the equation (1) the variation of averages, which leads to the following expression:

$$D = {\sum }_{p ∈ Z} {( IG 0 [ p ] - μ 0 - IG {1}_{mc} [ p ] + μ 1 )}^{2} \qquad ( 2 )$$

wherein μ0 and μ1 are the estimated averages of respective luminances of IG0 and IG1_{mc} over the current area Z.

This estimation is followed by a direct comparison of signals for the areas of low local gradient. If D is less than a predefined threshold λ, IG0 and IG1 are considered to be coherent over the area. The threshold λ can, for example take as a value 5²×N_{Z}, N_{Z} being the number of points of the current area Z. This implies, in this case, that an average inter-signals deviation of 5 is tolerated.

If the preceding test 302 is negative, a measurement of the local gradient is carried out 303, and this for the areas of high local gradient. The high value of D can be due, for example, to a slight deviation, of less than a pixel, of an area that is textured and thus has high gradients. If the two signals are coherent, IG1_{mc} can be expressed for any pixel p in the current area with the expression:

IG1_{mc}[p]≈IG0[p+δ] (3)

wherein δ=(δx, δy) is a vector for which the two components δx and δy are of an amplitude less than 1, as a resetting to the pixel has already been done.

It is then possible, after a Taylor development of the equation (3) and considering the expression (2) to determine a greater value S of D fore which the expression is:

$$D \leq S = {\sum }_{p ∈ Z} {( \frac{\partial IG 0}{\partial x} [ p ] )}^{2} + {\sum }_{p ∈ Z} {( \frac{\partial IG 0}{\partial y} [ p ] )}^{2} + 2 \cdot \vert {\sum }_{p ∈ Z} ( \frac{\partial IG 0}{\partial x} [ p ] \frac{\partial IG 0}{\partial y} [ p ] ) \vert \qquad ( 4 )$$

The local gradients are thus calculated 303, then the sum S is compared 304 with D. If D is less than or equal to S, IG0 and IG1 are considered to be coherent over the current area Z. In the contrary case, IG0 and IG1 are considered to be non-coherent over the current area.

Some parameters such as excₘₐₓ and λ intervening in the algorithm can be coded and transmitted to the decoder.

It was seen with the example of FIG. 4 that when a compared area is considered coherent, a merging of the two signals IG0 and IG1 can be considered. The merging algorithm aims to mix the two signals satisfactory way, that is to say without causing the appearance of echoes due to the slight spatial deviation referred to earlier. One solution is to use piling without stitching algorithms of “Graph cut” type. One example of this type of technique is described in the article by Vivek Kwatra et al. entitled “Graphcut Textures: Image and Video Synthesis Using Graph Cuts”, Proc. ACM Transactions on Graphics, Siggraph'03. These algorithms enable fragments of texture to be assembled while limiting the apparent stitch type visual artefacts.

1. A method for video coding, at least one digital picture sequence, the pictures of said sequence being able to be intermediary pictures or key pictures used as references for the coding by motion compensation of intermediary pictures, wherein the intermediary pictures are coded per area based on a global motion compensation GMC in the forward and backward directions from key pictures, the areas of the intermediary picture being constructed either by merging of areas of global motion compensated key pictures, or by conventional coding, the choice between merging and conventional coding being made according to the result of a measurement of coherence between the signals of areas of global motion compensated key pictures.

2. A method for video coding according to claim 1, wherein the reference pictures are coded before the intermediary pictures and that at least one segmentation map associated with said pictures is calculated in a way to be able to distinguish the GMC type pixels from other pixels of these pictures.

3. A method for video coding according to claim 1, wherein the global motion parameters are estimated and coded before the coding of intermediary pictures.

4. A method for video coding according to claim 3, wherein motion compensated key pictures are deduced from key pictures using at least the global motion parameters.

5. A method for video coding according to claim 4, wherein segmentation maps associated with the motion compensated key pictures are deduced from segmentation maps associated with key pictures by transpositions using at least the motion estimation parameters.

6. A method for video coding according to claim 4, wherein the intermediary picture to be coded as well as the motion compensated key pictures used for its coding are divided into processing areas, the processing areas of the intermediary picture to be coded corresponding to the processing areas of motion compensated key pictures.

7. A method for video coding according to claim 1, wherein the processing areas of motion compensated key pictures are classed according, to their proportion of GMC pixels, said proportion being compared to a threshold η comprised between 0 and 1, an area being classed “GMC” when said proportion is greater than η and classed “non-GMC” in the contrary case.

8. A method for video coding according to claim 7, wherein the proportion of GMC pixels per area of motion compensated key pictures is deduced from segmentation maps.

9. A method for video coding, according to claim 7, wherein if at least one area of one of the motion compensated pictures and used as references for the coding of the area to be coded of an intermediary picture is classed “non-GMC”, a conventional coding of said area is carried out.

10. A method for video coding according to claim 7, wherein if the areas of motion compensated pictures used as references for the coding of an area of an intermediary picture are classed “GMC”, the coherence of said areas is analysed by comparison of signals of areas of global motion compensated key pictures.

11. A method for video coding according to claim 10, wherein the average quadratic error D of the area to be coded is calculated and is compared to a predefined threshold λ in a way to distinguish the areas with low local gradient from areas with high local gradient, the area being considered to have low local gradient and is classed “coherent” if D is less than λ and being considered to have high local gradient in the contrary case.

12. A device for video coding of at least one digital picture sequence, the pictures of said sequence being able to be intermediary pictures or key pictures used as references for the coding by motion compensation of intermediary pictures, the coding device comprising means for:
coding the intermediary pictures per area on the basis of a global motion compensation GMC in the forward direction and the backward direction from key pictures, the areas of the intermediary picture being coded either by merging of corresponding areas of key pictures, or by conventional coding,
selecting automatically between merging and conventional coding according to the result of a measurement of coherence between the signals of areas of global motion compensated key pictures.

13. A device for video decoding of at least one digital picture sequence previously coded using the method according to claim 1, the pictures of said sequence being able to be intermediary pictures or key pictures used as references for the decoding by motion compensation of intermediary pictures, the device for decoding comprising means for decoding the intermediary pictures per area on the basis of a global motion compensation GMC in the forward and backward directions from decoded key pictures, the areas of the intermediary picture being reconstructed either by merging of areas of global motion compensated key pictures, or by conventional decoding, the choice between merging and conventional decoding being made according to the result of a measurement of coherence between the signals of areas of global motion compensated key pictures.

14. A method for video coding according to claim 1, wherein the estimation of vectors of backward θ₀=(M₀,T₀) and forward θ₁=(M₁,T₁) global motion parameters of a picture or part of an intermediary picture, for the implementation of said global motion compensation respectively in the backward and forward direction, is restricted to two degrees of freedom by deducing θ₀ and θ₁ from two parameters α₀ and α₁ verifying the equations:
$$\{ \begin{matrix}{M}_{0} = {α}_{0} \cdot M \\ {T}_{0} = {α}_{0} \cdot T\end{matrix} and \{ \begin{matrix}{M}_{1} = {α}_{1} \cdot ⌊ I - {( I - M )}^{- 1} ⌋ \\ {T}_{1} = {α}_{1} \cdot ⌊ - {( I - M )}^{- 1} \times T ⌋\end{matrix}$$

15. A method for video coding according to claim 1, wherein the estimation of vectors of backward θ₀=(M₀,T0) and forward θ₁=(M₁,T₁) global motion parameters of an intermediary picture, for the implementation of said global motion compensation respectively in the backward and forward direction, is restricted to one degree of freedom by deducing θ₀ and θ₁ from a parameter α verifying the equations:
$$\{ \begin{matrix}{M}_{0} = α \cdot M \\ {T}_{0} = α \cdot T\end{matrix} and \{ \begin{matrix}{M}_{1} = ( α - 1 ) \cdot {( I - M )}^{- 1} M \\ {T}_{1} = ( α - 1 ) \cdot {( I - M )}^{- 1} T\end{matrix}$$
